(19) United States
(12) Patent Application Publication
(10) Pub. No.: US 2008/0084944 A1
(43) Pub. Date: Apr. 10, 2008

(54) Interference cancellation and spatial multiplexing in wireless local area networks with multiple-input-multiple-output wireless stations

(76) Inventors: Minyoung Park, Portland, OR (US); Guoqing Li, Hillsboro, OR (US); Liuyang Lily Yang, Portland, OR (US)

Correspondence Address: SETH KALSON;c/o INTELLEVATE, LLC, P.O. BOX 52050, MINNEAPOLIS, MN, 55402, US

(21) Appl. No.: 11/545,146

(22) Filed: Oct. 10, 2006

(51) Int. Cl. H04L 1/02

(52) U.S. Cl. 375/267

(57) ABSTRACT

In a wireless local area network employing multiple-input-multiple-output stations, apparatuses and methods are disclosed to increase throughput of the network when the communication path between two communicating stations has a strong line-of-sight component. An embodiment performs a singular value decomposition on the channel matrix for the strongly line-of-sight channel, and transmits information regarding the singular value decomposition. Other stations may utilize this information to vector encode and vector decode their transmissions so as not to interfere with the two communicating stations, thereby increasing network utilization. Other embodiments are described and claimed.

### FIELD

Embodiments relate to wireless digital communication systems, and more particularly, to wireless local area networks with multiple-antenna stations.

### BACKGROUND

Multi-path wireless channels are capable of large channel capacities, and may be properly exploited through the use of an MIMO (Multiple-Input-Multiple-Output) communication system. An MIMO system employs multiple transmit antennas and multiple receive antennas. Standard IEEE 802.16e, sometimes referred to as Mobile Worldwide Interoperability for Microwave Access (Mobile WiMAX), supports MIMO antenna technology. Future wireless networks will also support MIMO antenna technology. There have been efforts to introduce a unified proposal for the next generation of high performance wireless networks, developed under the guidelines of the IEEE Standards Association and submitted to the IEEE 802.11n Task Group N (TGn). One of the goals is to enable MIMO Spatial Division Multiplexing to provide reliable transmission speeds of up to 315 megabits per second (Mbps) with two antennas, and up to 630 Mbps with larger systems employing more than two antennas.

Access point density in an enterprise WLAN (Wireless Local Area Network) is expected to increase to where the typical distance between an access point and a client may at times be 10 feet or less. As a result, the effect of line-of-sight (LOS) communication is expected to become important. An MIMO system works well in non line-of-sight (NLOS) channel environments having many scatterers. A communication link having a strong LOS component increases spatial signal correlation, so as to diminish the benefit of an MIMO system.

Accordingly, it is useful to provide communication technology in a multiple antenna client that may be configured to perform well when a LOS communication path is dominant.

Furthermore, for currently deployed systems, in a contention based WLAN there is only one active communication link in the same contention floor at a time. This may limit the total network traffic that the WLAN may in theory be able to provide. Accordingly, it is useful to provide a communication technology and protocol that may take advantage of MIMO system capability in the presence of an LOS channel, and where the MIMO WLAN is utilized more effectively.

### BRIEF DESCRIPTION OF THE DRAWINGS

FIG. 1 illustrates a prior art communication system.

FIG. 2 illustrates channel matrices for the communication system of FIG. 1.

FIG. 3 illustrates a network according to an embodiment of the present invention.

FIGS. 4A, 4B, 5A, 5B, 6A, 6B, 7A, and 7B illustrate protocols and signal processing for the embodiment of FIG. 3.

FIG. 8 is a flow diagram according to an embodiment of the present invention.

FIG. 9 illustrates a computer system in which an embodiment of the present invention finds application.

### DESCRIPTION OF EMBODIMENTS

In the descriptions that follow, the scope of the term “some embodiments” is not to be so limited as to mean more than one embodiment, but rather, the scope may include one embodiment, more than one embodiment, or perhaps all embodiments.

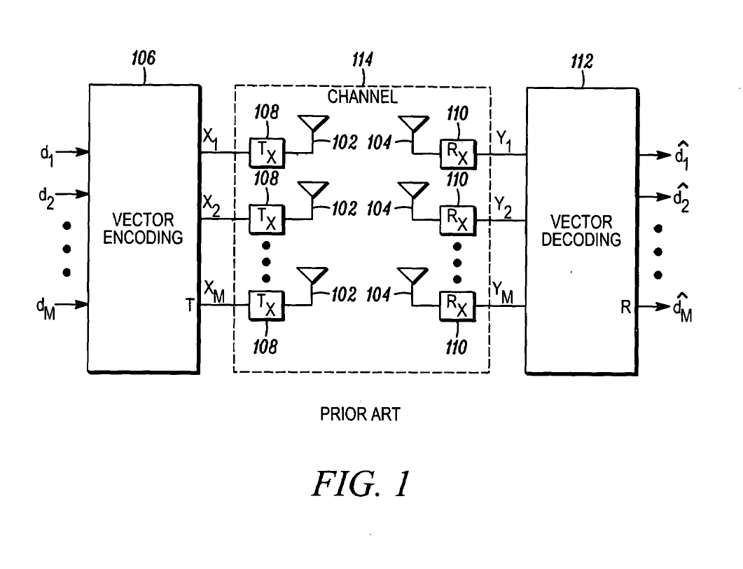

Before describing embodiments of the invention, it is useful to introduce terminology. FIG. 1 is a high-level system diagram of a portion of an MIMO system utilizing M transmit antennas 102 and M receive antennas 104. The symbols dᵢ, i=1, . . . , M represent M complex-valued data quantities to be transmitted. These data quantities may arise by de-multiplexing one or more data stream into M data streams, where coding may have been applied.

Vector Encoding functional unit 106 encodes dᵢ, i=1, . . . , M into M complex-valued quantities xᵢ, i=1, . . . , M. Defining d̅ as an M-dimensional column vector having components [ d̅]ᵢ=dᵢ, i=1, . . . , M, and defining x̅ as an M-dimensional column vector having components [ x̅]ᵢ=xᵢ, i=1, . . . , M, one may write the vector encoding as

x̅=T d̅,

where T denotes a complex-valued M by M matrix.

The complex-valued quantities xᵢ, i=1, . . . , M represent the in-phase and quadrature components of a baseband signal, such as a voltage signal, to be transmitted over a channel. Functional units 108 (e.g., transmitters) modulate and up-convert the baseband signal x̅ to an RF (radio-frequency) signal before transmission by antennas 102, although the scope of the embodiment is not limited in this regard.

Receivers 110 down-convert the received signals provided by antennas 104 into the M complex-valued baseband signals yᵢ, i=1, . . . , M. Vector Decoding functional unit 112 indicates that the M complex-valued baseband signals yᵢ, i=1, . . . , M are decoded into the M complex-valued baseband signals \hat{d}ᵢ, i=1, . . . , M. Defining [symbol] as an M-dimensional column vector having components [symbol] =\hat{d}ᵢ, i=1 . . . , M, and defining y̅ as an M-dimensional column vector having components [ y̅]ᵢ=yᵢ, i=1, . . . , M, one may write the vector decoding as

$$\overline{\hat{d}} = R \overline{y} ,$$

where R denotes a complex-valued M by M matrix. It is desirable that the quantities \hat{d}ᵢ, i=1, . . . , M are in some sense a good estimate of dᵢ, i=1, . . . , M.

There are various ways to define a communication channel. In FIG. 1, a communication channel may be defined to include the components within dashed box 114. For this model of a communication channel, the channel inputs are xᵢ, i=1, . . . , M and the channel outputs are yᵢ, i=1, . . . , M.

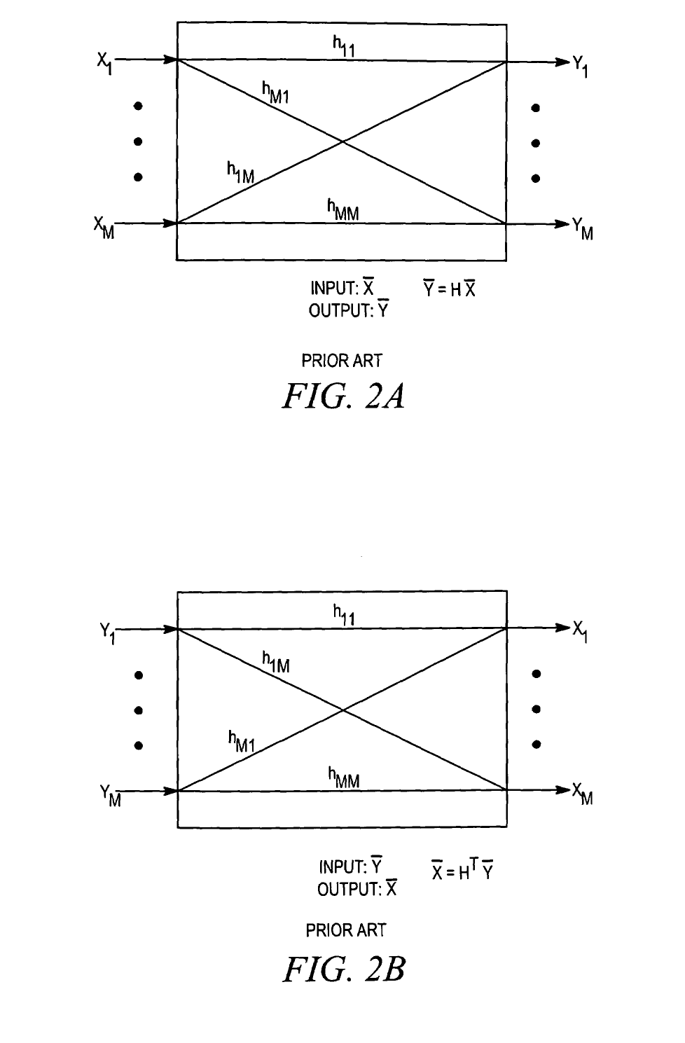

The channel defined by box 114 may be abstracted as shown in FIG. 2A. For simplicity, the channel depicted in FIG. 2A is a stationary, noiseless channel. However, in practice, there will be noise sources, and the channel transfer function may be fading.

In FIG. 2A, hᵢⱼ, i=1, . . . , M; j=1, . . . , M are complex-valued scalars representing the channel gains due to the gains of the transmit antennas, receive antennas, transmitters, and receivers. It is convenient to define hᵢⱼ as

hᵢⱼ=(Txⱼ)(TGⱼᵢ)wⱼᵢ(RGⱼᵢ)(Ryᵢ),

where Txⱼ is the gain of the transmitter for symbol xⱼ; TGⱼᵢ is the antenna gain for the transmit antenna associated with xⱼ in the direction toward the receive antenna associated with symbol yᵢ; RGⱼᵢ is the antenna gain for the receive antenna associated with symbol yᵢ for a signal received from the direction of the antenna associated with symbol xⱼ; Ryᵢ is the gain for the receiver for the symbol yⱼ; and wⱼᵢ is the response of the physical transmission medium between transmit antenna j and receive antenna i.

Defining the M by M channel matrix H to have components [H]ᵢⱼ=hᵢⱼ, i=1, . . . , M; j=1, . . . , M, the input-output relationship defined by the channel matrix H is

y̅=H x̅

In general, the channel matrix for the channel in which yᵢ, i=1, . . . , M are transmitted and xᵢ, i=1, . . . , M are received, is different from H. This is so because for this channel, receivers are used to generate the xᵢ, i=1, . . . , M instead of transmitters 108, and transmitters are used to generate the yᵢ, i=1, . . . , M instead of receivers 110, and as a result, the overall channel gains may be different. However, if one assumes that the channel is calibrated to take into account the differences in transmitter and receiver gains for both directions, then the same channel gains hᵢⱼ, i=1, . . . , M; j=1, . . . , M as indicated in FIG. 2A also hold for the channel of FIG. 2B, where now yᵢ, i=1, . . . , M are the channel inputs and xᵢ, i=1, . . . , M are the channel outputs. With this assumption, the two-way channel is said to be reciprocal, and the input-output relationship for the channel of FIG. 2B is given by

x̅=H^{T} y̅,

where ^{T} denotes transposition.

To perform SVD (Singular Value Decomposition) beamforming, the SVD of the channel matrix is computed. Consider the channel of FIG. 2A with channel matrix H. The SVD of H is

H=UΣV^{H},

where ^{H} denotes complex conjugate transpose (not to be confused with the channel matrix H), U is an M by M unitary matrix, Σ is an M by M diagonal matrix where the diagonal values are the singular values of H, and V is an M by M unitary matrix. Once the SVD of the channel matrix is computed, SVD beamforming is formed by multiplying the transmitted data vector d̅ by V. That is, Vector Encoding 106 is chosen such that T=V, so that

x̅=V d̅.

Using the above SVD beamformer and SVD of H, the received signal vector, y̅, is:

y̅=H x̅=HV d̅=UΣV^{H}V d̅=UΣ d̅,

where we have used the unitary property V^{H}V=I. If now Vector Decoding 112 multiplies y̅ by U^{H}, that is R=U^{H} in Vector Decoding 112, then [symbol] is given by

$$\overline{\hat{d}} = R \overline{y} = {U}^{H} \overline{y} = {U}^{H} U \sum \overline{d} = \sum \overline{d} .$$

Because Σ is diagonal, we see that mixing of the different transmitted signal components due to the multipath channel has been removed by employing SVD beamforming. That is,

$${[ \overline{\hat{d}} ]}_{i} = {{σ}_{i} [ \overline{d} ]}_{i} , i = 1 , … , M ,$$

where σᵢ, i=1, . . . , M are the singular values.

In the above discussion, we have assumed a noiseless channel. If the channel includes zero-mean, stationary Gaussian noise with covariance matrix G, then because of the unitary property of U, we have

$$\overline{\hat{d}} = \sum \overline{d} + \overline{n} ,$$

where n̅ is Gaussian with covariance matrix G. Then we see that the signal-to-noise ratio for each component of the estimate vector [symbol] depends upon the singular values, as well as G.

The above SVD of H requires knowledge of H. The columns of the channel matrix H may easily be observed by transmitting such that only one component of x̅ is non-zero. For example, if the first component of x̅ were 1 and all the other components were zero, then y̅ would be the first column of H (in the noiseless case).

A problem with MIMO systems is that some of the singular values of the channel matrix may be relatively very small compared to the largest singular value. This may happen when the communication channel does not have enough different propagation paths from a transmitting station to a receiving station. This may also happen when the communication channel has a strong LOS component. As a result, the full benefits of spatial multiplexing may not be realized, and performance may suffer. For WLAN systems, embodiments of the present invention exploit the case in which the channel matrix has one or more relatively small singular values so as to provide an increase in overall network utilization.

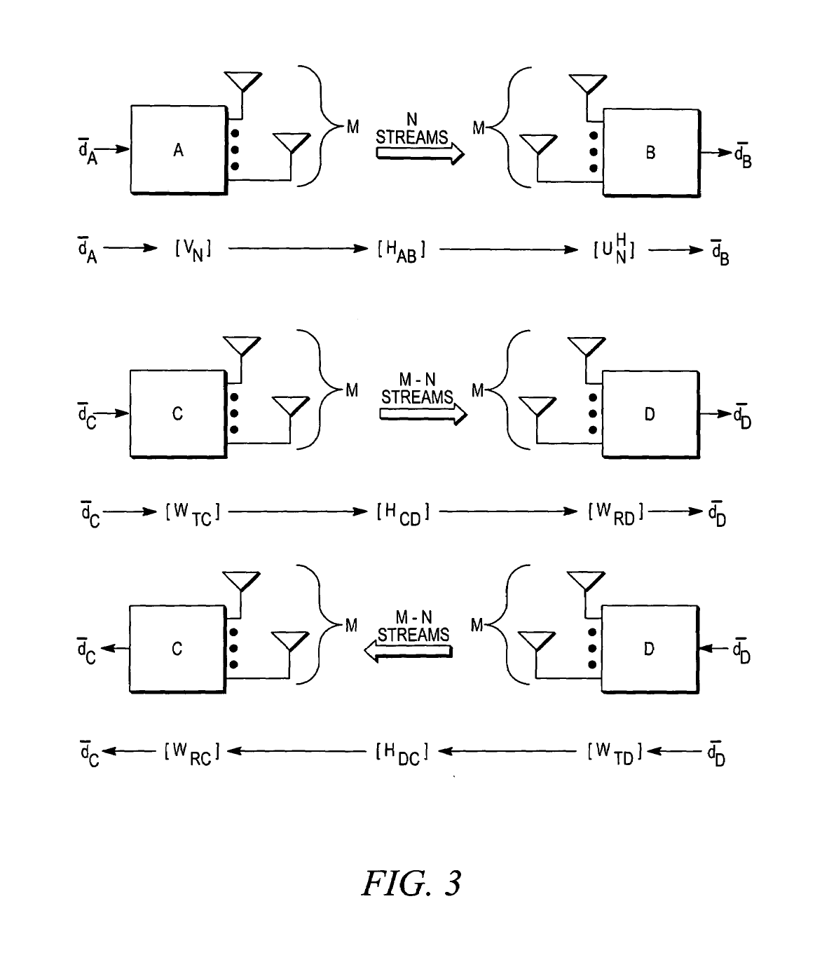

Embodiments find application to a large variety of networks, but for simplicity, an embodiment may be described with respect to the wireless network illustrated in FIG. 3, comprising four stations: station A, station B, station C, and station D. Some or all of these stations may be fixed, or mobile. In the particular example of FIG. 3, each station is an MIMO system, with each station having M antennas for transmission and reception.

Suppose station A has data vector d̅_{A} to send to station B. By performing an SVD on the channel matrix for the communication channel from station A to station B, embodiments provide the number of spatial streams, N, that station A may transmit to station B, where N≦M. If N<M, then stations C and D may communicate to each other while station A is transmitting to station B, such that interference is mitigated. In this way, it is expected that embodiments may provide an overall increase in network utilization.

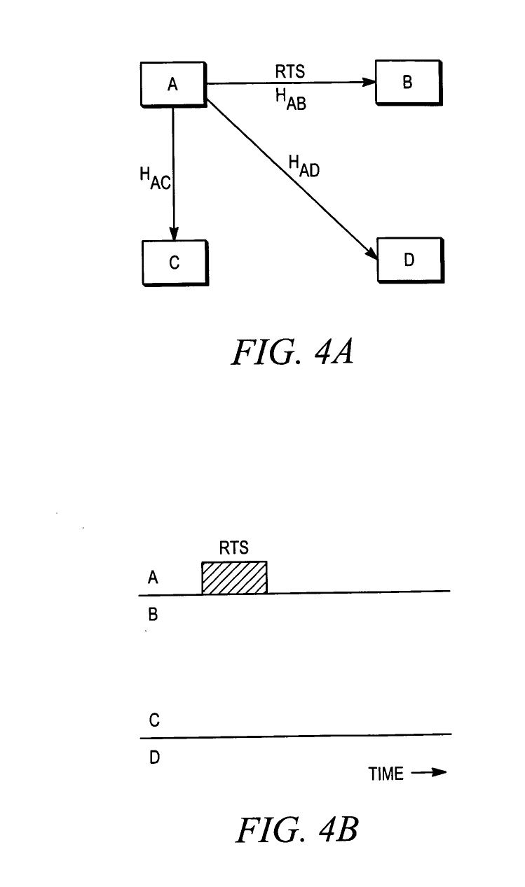

To configure the MIMO system and to determine the number of spatial streams that the communication channel between stations A and B may support, station A transmits an RTS (Request-To-Send) packet, or other packet, to station B, so that station B may estimate the channel matrix for the communication channel from station A to station B. Let H_{AB} denote this channel matrix. (For ease of discussion, a channel matrix is not distinguished from its estimate. For example, H_{AB} may be viewed as the actual channel matrix for station A transmitting to station B, or as its estimate. It is clear from context which view should be taken.) Stations C and D listen to the communication from station A to estimate the channel matrices for the communication channels from station A to station C, and from station A to station D, respectively. Let H_{AC} and H_{AD} denote these channel matrices, respectively. This procedure is diagrammatically illustrated in FIGS. 4A and 4B, where FIG. 4A indicates that stations C and D are listening to station A, and FIG. 4B indicates that station A has sent an RTS packet to station B. (A packet other than an RTS packet may be used.)

The number of spatial streams that may be supported by the communication channel comprising station A transmitting to station B is provided by performing an SVD on H_{AB}. Denote the SVD of H_{AB} as H_{AB}=UΣV^{H}. The singular values may be arranged in decreasing order, so that the first diagonal element of Σ is a singular value having the maximum value of the singular values, and the last diagonal element of Σ is a singular value having the minimum value of the singular values. That is, the M by M matrix H_{AB} may be decomposed as

$${H}_{AB} = {\sum }_{i = 1}^{M} {σ}_{i} {u}_{i} {v}_{i}^{H} ,$$

where σ₁≧σ₂≧ . . . σ_{M}≧0 are the singular values, uᵢ is the i^{th} column of the M by M unitary matrix U, and vᵢ is the i^{th} column of the M by M unitary matrix V. For some embodiments, the number of available data streams, N, is the number of singular values greater than some suitably chosen threshold, ε. That is, N is the largest index j for which σⱼ>ε. The threshold ε may be found by simulation or experiment, and is chosen to give good performance.

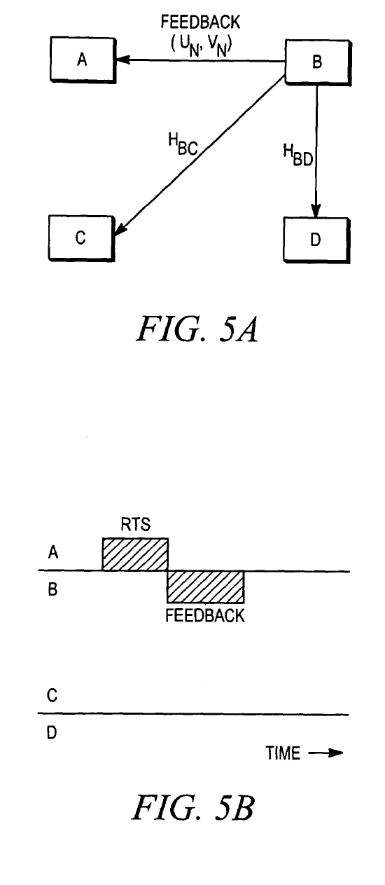

If N<M, then station B sends feedback to station A to indicate that N<M. Assume that N<M. This feedback provides the first N columns of U, denoted as the M by N matrix U_{N}, and the first N columns of V, denoted as the M by N matrix V_{N}. Stations C and D listen to this information, so that U_{N} and V_{N} are known to these stations, estimates the channel matrix for the communication channel comprising station B transmitting to station C, H_{BC}, and estimates the channel matrix for the communication channel comprising station B transmitting to station D, H_{BD}. This procedure is diagrammatically illustrated in FIGS. 5A and 5B. FIG. 5A illustrates the information provided by station B. FIG. 5B illustrates that station B sends feedback to station A after having received an RTS packet, and stations C and D are in a listening mode.

With a packet (e.g., an RTS packet) sent from station A to station B, and a feedback packet (or packets) sent from station B to station A, the following information is known (or estimated) by the stations: The M by N matrices U_{N} and V_{N}; and the channel matrices H_{AB}, H_{AD}, H_{AC}, H_{BC}, and H_{BD}. Assuming a reciprocal channel, the channel matrix, H_{CB}, for the communication channel comprising station C transmitting to station B is given by H_{CB}=H_{BC}^{T}, and the channel matrix, H_{DB}, for the communication channel comprising station D transmitting to station B, is given by H_{DB}=HB_{BD}^{T}.

With this information, station A transmits N streams of data. The dimension of the data vector d̅_{A} in FIG. 3 is N, and is vector encoded by the matrix V_{N}, so that the transmitted vector is V_{N} d̅_{A}. Note that this transmitted vector has dimension M, but there are N<M degrees of freedom. Station B vector decodes its received vector by U_{N}^{H}. The total signal processing chain for communication from station A to station B is represented in FIG. 3 as a chain of matrix multiplication, as shown under stations A and B, where the total multiplicative matrix is U_{N}^{H}H_{AB}V_{N}.

While station A is transmitting to station B the vector V_{N} d̅_{A}, stations C and D may also communicate with each other, provided if during some defer time interval after station B has completed sending feedback information to station A, and station A is now sending data to station B, there are no other nodes communicating with each other. The defer time interval is introduced to resolve contention between other neighboring nodes that may try to initiate their communications. During the defer time interval, station C vector decodes (filters) it received signals with an M−N by M matrix W_{RC} to mitigate interference from station A so that it may listen to determine if other nodes try to initiate communication during the defer time interval.

The matrix W_{RC} is chosen to satisfy the relationship

W_{RC}H_{AC}V_{N}=0_{N}^{T}, (1)

where 0_{N} is the all-zero N by M−N matrix. With this relationship, it is easily seen that interference from station A to station C is mitigated. Observe that the received data vector d̅_{C} at station C when station A is transmitting is, in the noiseless case, given by

d̅_{C}=W_{RC}H_{AC}V_{N} d̅_{A}= 0̅_{M-N},

where eq. (1) is used, and 0̅_{M-N} is the all zero vector of dimension M−N. Thus, interference from station A is filtered out. If during the defer time interval station C does not hear communication from other nodes, then it may begin transmitting information to station D, provided it determines that its exchange with station D will finish not later than when station A is done transmitting its data to station B.

The relationship of eq. (1) represents under-determined sets of equations for solving the matrix W_{RC}. Additional constraints may be introduced so W_{RC} may be uniquely determined. For example, a minimum norm on W_{RC} may be introduced. Alternatively, additional linear constraints may be introduced. For example, W_{RC} may be chosen to satisfy the relationship

[W_{RC}][H_{DC}|H_{AC}V_{N}]=[I_{N}^{T}|0_{N}^{T}], (1A)

where I_{N} is an M by M−N matrix where all elements are zero except that [I_{N}]ⱼⱼ=1, j=1,2, . . . , M−N.

In the above relationships, the channel matrix H_{DC} need not be known, but any full rank matrix may be used for H_{DC}. Standard numerical techniques may be employed to solve the above matrix equations, eq. (1A), or the relationship, eq. (1), with additional constraints imposed. Solving for the matrix W_{RC} may be performed by station C.

If no other nodes are communicating during the defer time interval, and if station C will finish its transmission no later than station A, station C may begin transmitting data to station D. To mitigate interference, when station C transmits to station D, it vector encodes its data, d̅_{C}, by an M by M−N matrix W_{TC}, and station D vector decodes its received data by an M−N by M matrix W_{RD} to provide d̅_{D}. This is represented by the signal processing chain shown immediately under stations C and D in FIG. 3. The matrices W_{TC} and W_{RD} are chosen to satisfy, respectively, the relationships

U_{N}^{H}H_{CB}W_{TC}=0_{N}, (2)

and

W_{RD}H_{AD}V_{N}=0_{N}^{T}. (3)

The vectors d̅_{C} and d̅_{D} each have dimension M−N, so that M−N streams of data may be communicated between stations C and D. It is interesting to note that the total number of data streams communicated in the example network of FIG. 3 is M. That is, the communication path between stations A and B allows for N independent data streams, and the communication path between stations C and D allows for M−N independent data streams, for a total of M independent data streams.

The above two displayed equations represent under-determined sets of equations for solving for the matrices W_{TC} and W_{RD}. As discussed with respect to eq. (1), additional constraints may be introduced so that these matrices may be uniquely determined, such as, for example, a minimum norm on the matrices may be introduced, or additional linear constraints may be introduced. For example, the matrices may be chosen to satisfy the relationships

$$\begin{matrix}[ \begin{matrix}{H}_{CD}^{T} \\ {U}_{N}^{H} {H}_{CB}\end{matrix} ] [ {W}_{TC} ] = [ \begin{matrix}{I}_{N} \\ {0}_{N}\end{matrix} ] , \\ and & ( 2 A ) \\ [ {W}_{RD} ] [ {H}_{CD} \text{\textbar} {H}_{AD} {V}_{N} ] = [ {I}_{N}^{T} \text{\textbar} {0}_{N}^{T} ] . & ( 3 A )\end{matrix}$$

In the above relationships, the channel matrix H_{CD} need not be known, but any full rank matrix may be used for H_{CD}. Standard numerical techniques may be employed to solve the above matrix equations, eqs. (2A) and (3A), or the two relationships, eqs. (2) and (3), with additional imposed constraints. Solving for these matrices may be performed at their respective stations. That is, station C may solve for W_{TC}, and station D may solve for W_{RD}.

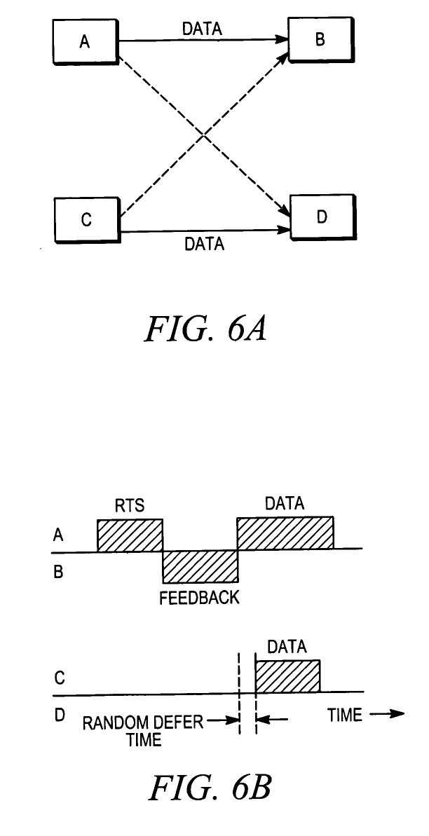

FIG. 6A illustrates station A transmitting to station B, and station C transmitting to station D. The channel paths from station C to station B, and from station A to station D, are dashed to indicate that these communication paths represent unwanted interference, and that this interference is mitigated because station C vector encodes with W_{TC} and station D vector decodes with W_{RD}. This is easily seen by observing that the vector d̅_{B} at station B is, in the noiseless case,

d̅_{B}=U_{N}^{H}H_{AB}V_{N} d̅_{A}+U_{N}^{H}H_{CB}W_{TC} d̅_{C}=U_{N}^{H}H_{AB}V_{N} d̅_{A},

because U_{N}^{H}H_{CB}W_{TC} d̅_{C}=0 from eq. (2). Thus, station C (in the ideal case) does not interfere with station B receiving data from station A. Note that if the truncated SVD representation

$${H}_{AB} \approx {\sum }_{i = 1}^{N} {σ}_{i} {u}_{i} {v}_{i}^{T}$$

is a sufficiently good representation for H_{AB}, then (in the noiseless case)

d̅_{B}=U_{N}^{H}H_{AB}V_{N} d̅_{A}=Σ_{N} d̅_{A},

where Σ_{N} is an N by N diagonal matrix with the singular values σᵢ, i=1, . . . , N as its diagonal elements. As a result, the N data streams transmitted from station A are recovered at station B.

The vector d̅_{D} at station D is, in the noiseless case,

d̅_{D}=W_{RD}H_{AD}V_{N} d̅_{A}+W_{RD}H_{CD}W_{TC} d̅_{C}=W_{RD}H_{CD}W_{TC} d̅_{C},

because W_{RD}H_{AD}V_{N} d̅_{A}= 0̅_{M-N} from eq. (3). Thus, station A does not, in the ideal case, interfere with station D. Provided W_{RD}H_{CD}W_{TC} has rank M−N, the transmitted M−N data streams from station C may be recovered at station D. Note that if eq. (3A) is satisfied, W_{RD}H_{CD}W_{TC} d̅_{C}=W_{TC} d̅_{C}.

FIG. 6B illustrates the transfer of information over time. After station A has transmitted an RTS packet to station B, and station B has responded with feedback information, as discussed earlier, station A transmits data to station B. Station C transmits data to station D if, after some defer time interval has elapsed since the time that station A begins transmitting data to station B, station C does not hear any other communication nodes. For some embodiments, the defer time interval may be pre-selected, or chosen by a pseudo-random process. Note also from FIG. 6B that station C completes its data transmission to station D before station A has completed its data transmission to station B. In this way, by completing transmission before station A completes transmission, station C does not interfere with station B.

While station A is still transmitting to station B, station D may transmit to station C. To mitigate interference, when station D transmits to station C, it vector encodes its data by an M by M−N matrix W_{TD}, and station C vector decodes its received data by the M−N by M matrix W_{RC}. This is represented by the signal processing chain shown under stations C and D in FIG. 3. The matrix W_{TD} is chosen to satisfy the relationship

U_{N}^{H}H_{DB}W_{TD}=0_{N}. (4)

The above displayed equation represents under-determined sets of equations for solving for the matrix W_{TD}. As discussed earlier, additional constraints may be introduced so that the matrix may be uniquely determined. For example, the matrix W_{TD} may be chosen to satisfy the relationship

$$[ \begin{matrix}{H}_{DC}^{T} \\ {U}_{N}^{H} {H}_{DB}\end{matrix} ] [ {W}_{TD} ] = [ \begin{matrix}{I}_{N} \\ {0}_{N}\end{matrix} ] . \qquad ( 4 A )$$

### From the relationship of eq. (4), it follows that interference from station D to station B is mitigated.

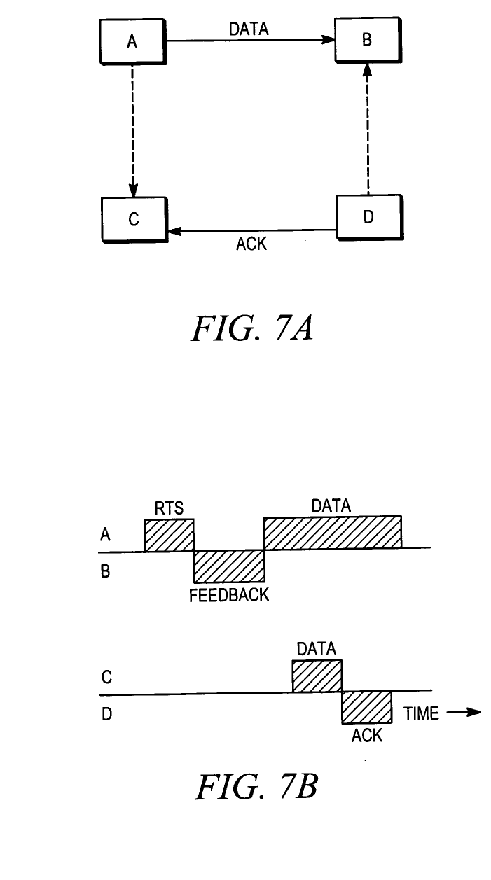

FIG. 7A illustrates station D sending an acknowledgement packet to station C while station A is still sending data to station B. The dashed communication paths indicate that interference from station A to station C, and from station D to station B, is mitigated. The time line for the packets is illustrated in FIG. 7B, indicating that the packets communicated between stations C and D occur while station A is still transmitting to station B.

For some embodiments, instead of station D transmitting an acknowledgement packet to station C while station A is still sending data to station B, station D may delay its acknowledgement packet transmission and transmit it as part of a block acknowledgement to the next packet transmission from station C to station D. This is expected to increase the efficiency of the MAC protocol, thereby increasing network throughput.

The above discussion regarding interference has assumed that N<M If, however, N=M, then station A communicates with station B in a conventional manner, and stations C and D are quiet.

Embodiments of the present invention are also applicable in legacy situations, where, for example, stations A and B may be SISO (Single-Input-Single-Output) systems. In that case, N=1, and 1=U_{N}=V_{N}, so that no SVD need be done, and information regarding U_{N} and V_{N} need not be transmitted. The above-displayed equations for solving W_{TC}, W_{RD}, W_{TD}, and W_{RC} still apply, but where now 1=U_{N}=V_{N}, resulting in the relationships

H_{CB}W_{TC}=0₁,

W_{RD}H_{AD}=0₁^{T},

H_{DB}W_{TD}=0₁,

and

W_{RC}H_{AC}=0₁^{T}.

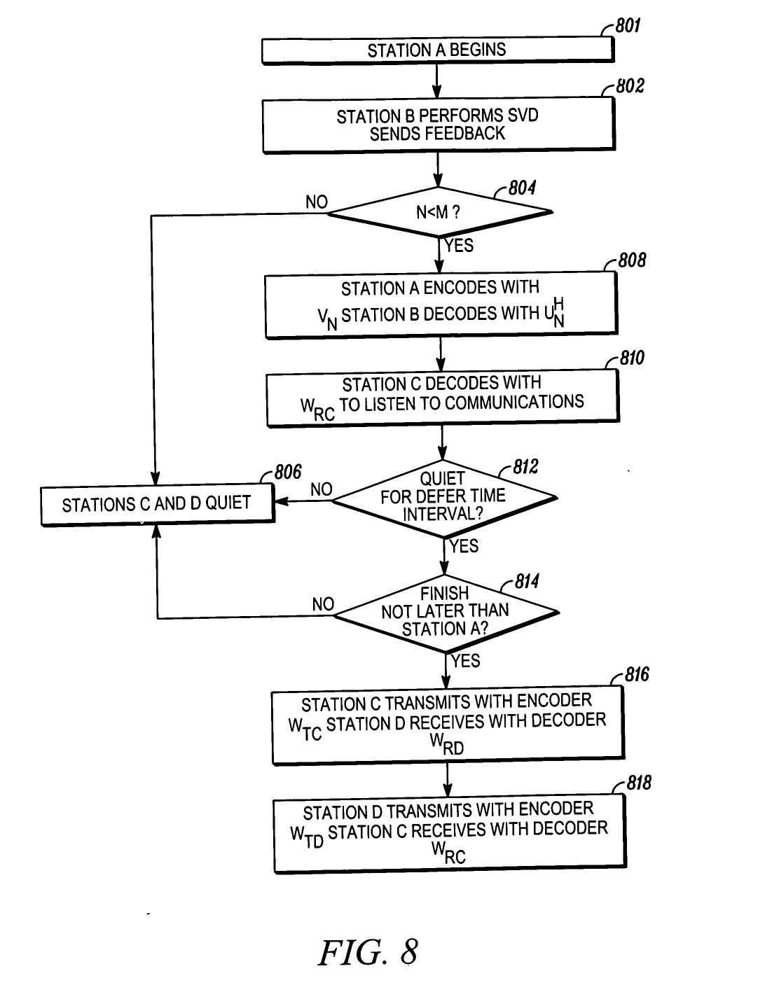

FIG. 8 illustrates a flow diagram for performing the procedures as discussed above. Station A begins transmitting in block 801. From this transmission, station B performs an SVD and sends feedback in block 802, indicating the number of singular values greater than some threshold, N, as well as the matrices U_{N} and V_{N}. If in block 804 it is determined that N=M, then control is brought to block 806 to indicate that stations C and D will not communicate while station A is transmitting. If in block 804 it is determined that N<M, then control is brought to block 808.

In block 808, station A vector encodes with V_{N}, and station B vector decodes with U_{N}^{H}. While station A is transmitting data to station B, in block 810 station C vector decodes with W_{RC} to cancel interference from station A so that it may listen to any other nodes that may be communicating. If in block 812 it is determined that there are no other nodes communicating for a defer time interval, other than station A, then control is brought to block 814, otherwise, control is brought to block 806.

In block 814, if it is determined that stations C and D will not be able to finish their communication by the time station A has finished its transmission, then control is brought to block 806, otherwise, control is brought to block 816. In block 816, station C transmits to station D, where station C vector encodes with W_{TC} and station D vector decodes with W_{RD}. After station C has completed its transmission to station D, station D transmits to station C, where station D vector encodes with W_{TD} and station C vector decodes with W_{RC}, as indicated in block 818.

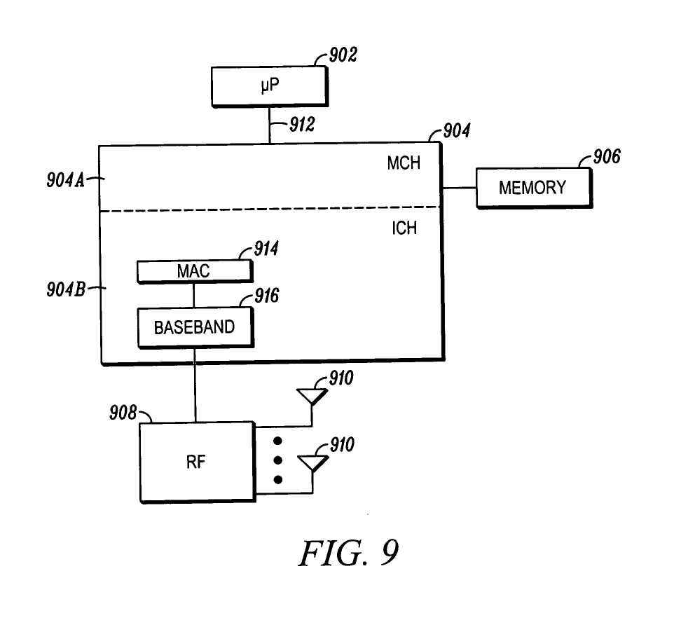

Embodiments of the present invention may find application to a wide range of electronic systems. As one particular example, embodiments may find application to a computer system. FIG. 9. illustrates, in simplified form, a portion of a computer system, comprising microprocessor 902, chipset 904, system memory 906, RF module 908, and antennas 910. In the particular embodiment of FIG. 9, chipset 904 includes MCH (Memory Controller Hub) 904A and ICH (Input/Output Controller Hub) 904B. Microprocessor 902 communicates with chipset 904 via front-side bus 912. MCH 904A serves as a controller for system memory 906. System memory 906 may comprise a hierarchically structured memory, where some portions may be integrated on microprocessor 902. Integrated in ICH 904B is MAC (Media Access Control) layer 914 and baseband module 916. The protocol layers higher than MAC layer 914 are not explicitly shown.

In the particular embodiment of FIG. 9, RF module 908 is part of the PHY (Physical) layer in the communication protocol stack. Baseband module 916 may also be viewed as part of the PHY layer. RF module 908 down-converts the RF signals received by antennas 910 to baseband signals, which are provided to baseband module 916. Baseband module 916 applies vector encoding and decoding. For example, if the computer system of FIG. 9 plays the role of station A in the example of FIG. 3, then it vector encodes with V_{N}, whereas if it plays the role of station B, then it vector decodes with U_{N}^{H}. If, however, the computer system of FIG. 9 were to play the role of station C, then it vector encodes with W_{TC} when in a transmitting mode, and vector decodes with W_{RC} when in a receiving mode. Similar statements apply to the case when the computer system of FIG. 9 plays the role of station D.

The computer system of FIG. 9 has the functional capability to perform a singular value decomposition, as well as the signal processing functions and protocols described in reference to FIGS. 3, 4A, 4B, 5A, 5B, 6A, 6B, 7A, 7B, and 8. Some, or all, of these functions may be performed in special purpose hardware, such as in one or more ASICs (Application Specific Integrated Circuit) or in programmable logic, or as software running on microprocessor 912, or any combination thereof. For speed, it is expected that much, or all, of the signal processing functions will be performed in hardware.

For some computer systems, MAC layer 914 and baseband module 916 may reside off chipset 904. Chipset 904 may itself comprise one or more discrete integrated chips, or some or all of its functional units may be integrated on microprocessor 902.

Various modifications may be made to the disclosed embodiments without departing from the scope of the invention as claimed below.

Various mathematical relationships may be used to describe relationships among one or more quantities. For example, a mathematical relationship or mathematical transformation may express a relationship by which a quantity is derived from one or more other quantities by way of various mathematical operations, such as addition, subtraction, multiplication, division, etc. Or, a mathematical relationship may indicate that a quantity is larger, smaller, or equal to another quantity. These relationships and transformations are in practice not satisfied exactly, and should therefore be interpreted as “designed for” relationships and transformations. One of ordinary skill in the art may design various working embodiments to satisfy various mathematical relationships or transformations, but these relationships or transformations can only be met within the tolerances of the technology available to the practitioner.

Accordingly, in the following claims, it is to be understood that claimed mathematical relationships or transformations can in practice only be met within the tolerances or precision of the technology available to the practitioner, and that the scope of the claimed subject matter includes those embodiments that substantially satisfy the mathematical relationships or transformations so claimed.

In particular, algorithms to perform singular value decompositions are iterative in nature, and are stopped at some point to end the computations. Furthermore, algorithms are performed with finite precision. Thus, it is to be understood that a singular value decomposition is not, in general, performed exactly, but only approximately.

What is claimed is:

1. An apparatus comprising:
a baseband module to vector decode when in a receive mode with an M−N by M matrix W_{R}, where W_{R}H_{R}V_{N}=0_{N}^{T}, where H_{R} is an estimated channel matrix having M rows, V_{N} is a matrix having N columns {vᵢ, i=1,2, . . . , N} where vᵢ^{H}vⱼ=0 if i≠j, and 0_{N} is an N by M−N matrix having all zeros, where M and N are integers such that N≦M.

2. The apparatus as set forth in claim 1, wherein H_{R} has M columns and V_{N} has M rows.

3. The apparatus as set forth in claim 1, wherein N=1, V_{N} is a scalar, and H_{R} has one column.

4. The apparatus as set forth in claim 1, wherein H_{R} is an estimated channel matrix where the apparatus is in a receive mode.

5. The apparatus as set forth in claim 1, the baseband module to vector encode when in a transmit mode with an M by M−N matrix W_{T}, where U_{N}^{H}H_{T}W_{T}=0_{N}, where H_{T} is an estimated channel matrix having M columns, and U_{N} is a matrix having N columns {uᵢ, i=1,2, . . . , N} where uᵢ^{H}uⱼ=0 if i≠j.

6. The apparatus as set forth in claim 5, wherein H_{T} has M rows, and U_{N} has M rows.

7. The apparatus as set forth in claim 5, wherein N=1, U_{N} is a scalar, and H_{T} has one row.

8. The apparatus as set forth in claim 5, wherein H_{R} is an estimated channel matrix where the apparatus is in a receive mode and H_{T} is an estimated channel matrix where the apparatus is in a transmit mode.

9. A method comprising:
estimating a channel matrix H_{1,2} for a communication channel from a first communication device to a second communication device;
provided H_{1,2} is an M by M matrix where M>1, performing a singular value decomposition on the channel matrix H_{1,2} so that
$${H}_{1 , 2} = {\sum }_{i = 1}^{M} {σ}_{i} {u}_{i} {v}_{i}^{H}$$
where σ₁≧σ₂≧ . . . σ_{M}≧0 are the singular values, uᵢ is the i^{th} column of an M by M unitary matrix U, and vᵢ is the i^{th} column of an M by M unitary matrix V;
provided H_{1,2} is an M by M matrix where M>1, the second communication device providing feedback information comprising an M by N matrix V_{N}, where V_{N} comprises the first N columns of V where 1≦N≦M;
estimating a channel matrix H_{1,3} for a communication channel from the first communication device to a third communication device; and
the third communication device listening with a vector decoder W_{R}, where provided H_{1,2} is an M by M matrix where M>1 and N<M, W_{R} satisfies W_{R}H_{1,3}V_{N}=0_{N}^{T}, where 0_{N} is an all-zero N by M−N matrix.

10. The method as set forth in claim 9, further comprising:
estimating a channel matrix H_{3,2} for a communication channel from the third communication device to the second communication device; and
the third communication device transmitting with a vector encoder W_{T}, where provided H_{1,2} is an M by M matrix where M>1 and N<M, W_{T} satisfies U_{N}^{H}H_{3,2}W_{T}=0_{N}.

11. The method as set forth in claim 10, wherein the third communication device transmits with the vector encoder W_{T} provided that, during the third communication device listening with the vector decoder W_{R}, no other communication is detected by the third communication device for a delay time interval.

12. The method as set forth in claim 9, further comprising:
the third communication device listening with a vector decoder W_{R}, where provided H_{1,2} is a scalar, W_{R} satisfies W_{R}H_{1,3}=0₁^{T}.

13. The method as set forth in claim 12, further comprising:
estimating a channel matrix H_{3,2} for a communication channel from the third communication device to the second communication device; and
the third communication device transmitting with a vector encoder W_{T}, where provided H_{1,2} is a scalar, W_{T} satisfies H_{3,2}W_{T}=0₁.

14. The method as set forth in claim 13, wherein the third communication device transmits with the vector encoder W_{T} provided that, during the third communication device listening with the vector decoder W_{R}, no other communication is detected by the third communication device for a delay time interval.

15. A computer system comprising:
a processor;
M antennas to transmit and receive up to M data streams;
memory; and
a memory controller to provide communication between the processor and the memory, the memory controller comprising a baseband module to estimate a channel matrix H_{R} having M rows for a communication channel in which the computer system is a receiver, to receive feedback information comprising a matrix V_{N} having N columns {vᵢ, i=1,2, . . . , N} where vᵢ^{H}vⱼ=0 if i≠j, and to vector decode when in a receive mode with an M−N by M matrix W_{R}, where W_{R}H_{R}V_{N}=0_{N}^{T}, where 0_{N} is an N by M−N matrix having all zeros, and where M and N are integers such that N≦M.

16. The computer system as set forth in claim 15, wherein H_{R} has M columns and V_{N} has M rows.

17. The computer system as set forth in claim 15, wherein N=1, V_{N} is a scalar, and H_{R} has one column.

18. The computer system as set forth in claim 15, the baseband module to receive feedback information comprising a matrix U_{N} having N columns {uᵢ, i=1, 2, . . . , N} where uᵢ^{H}uⱼ=0 if i≠j, to estimate a channel matrix H_{T} having M columns for a communication channel in which the computer system is a transmitter, and to vector encode when in a transmit mode with an M by M−N matrix W_{T}, where U_{N}^{H}H_{T}W_{T}=0_{N}.

19. The computer system as set forth in claim 18, wherein H_{T} has M rows, and U_{N} has M rows.

20. The apparatus as set forth in claim 18, wherein N=1, U_{N} is a scalar, and H_{R} has one row.
